(19) United States
(12) Patent Application Publication
(10) Pub. No.: US 2009/0237271 A1
(43) Pub. Date: Sep. 24, 2009

(54) DEVICE FOR PREVENTION OF SPEEDING, AND METHOD THEREOF

(76) Inventor: John Sundstrom, Gainesville, GA (US)

Correspondence Address: KAPLAN WARD & PATEL LLC, CUMBERLAND CENTER II, 3100 CUMBERLAND BLVD , SUITE 1400, ATLANTA, GA, 30339, US

(21) Appl. No.: 12/408,101

(22) Filed: Mar. 20, 2009

Related U.S. Application Data
(60) Provisional application No. 61/070,267, filed on Mar. 21, 2008.

(51) Int. Cl. G08G 1/01; G08B 21/00

(52) U.S. Cl. 340/936; 340/431

(57) ABSTRACT

A standalone vehicle speed detecting device that is portable and transportable, that creates the illusion of a police car when viewed by a vehicle driver, and that reacts to the detection of a speeding vehicle in a manner that simulates initial law enforcement vehicle engagement.

### CROSS-REFERENCE AND PRIORITY CLAIM TO RELATED APPLICATION

To the fullest extent permitted by law, the present U.S. Non-Provisional Patent Application claims priority to and the benefit of United States Provisional patent application entitled “Device for Prevention of Speeding, and Method Thereof,” filed on Mar. 21, 2008, on behalf of inventor John Sundstrom, and having assigned Ser. No. 61/070,267.

### FIELD OF THE INVENTION

The present invention relates generally to speed control devices, and more particularly, to device for prevention of speeding, and method thereof, wherein an illusion of police presence is created and whereby the psychological impact of the perceived threat of receiving a ticket encourages a passing driver to slow to a lawful speed.

### BACKGROUND OF THE INVENTION

Anyone who regularly drives can attest to the regular presence of drivers exceeding the speed limit. Of course, in addition to being illegal, speeding is dangerous and is frequently not only the cause of serious accidents due to loss of vehicle control, but is a direct contributing factor to the severity of the resulting injuries and property damage. Law enforcement officers regularly patrol highways and roads in an effort to identify and curtail speeders, stopping vehicles that are observed speeding and issuing a ticket. Unfortunately, such random manner of enforcement is disadvantageously ineffective.

Manned radar posts are sometimes utilized to increase the frequency of identification of speeding vehicles and to enhance the enforceability of the resulting citation. Working in a fixed position with a radar gun can allow for an increase in citations, and can thereby exert a direct minimizing effect on the total number of speeders within a given section of roadway. Nonetheless, such radar posts require the commitment of law enforcement personnel in order to operate, and thus are inherently limited by staffing and related budgetary limitations.

Recognizing these very real limitations in enforcement methods requiring live police presence, alternate modes have been proposed. One such method involves the use of cameras at traffic intersections, wherein vehicle license tags are recorded based upon illegal activities and tickets are mailed to the vehicle owner. Unfortunately, most traffic infractions occurring at intersections involve running a red light or improper turning, and thus such manner of enforcement is largely ineffective relative to speeding. Moreover, even if cameras could be positioned for speeding enforcement, any realized effect is via indirect deterrent value, as there is generally no incentive to slow speed until after receipt of the ticket via mail delivery; that is, there is no immediate revelation during the speeding event.

In an effort to elicit direct driver response, unmanned radar monitors have been described, wherein speed is displayed for oncoming vehicles, thereby informing a driver regarding his actual speed. Such devices may be effective at slowing some drivers, but are disadvantageously ineffective for many drivers who react only to the threat of being caught.

Therefore, it is readily apparent that there is a need for a device for prevention of speeding, and method thereof, wherein a functional, yet unmanned law enforcement post creates a perceived threat of citation and thereby elicits an immediate reduction in driver speed, thus avoiding the above-discussed disadvantages.

### BRIEF SUMMARY OF THE INVENTION

Briefly described, in a preferred embodiment, the present invention overcomes the above-mentioned disadvantages and meets the recognized need for such a device by providing a simulated police presence accompanied with realistic visual and audible effects in order to deliver the perceived threat of a citation to a speeding driver and to realize an immediate slow-down reaction therefrom.

According to its major aspects and broadly stated, in its preferred form, the present invention is a standalone vehicle speed detecting device that is portable and transportable, that creates the illusion of a police vehicle, such as a car or motorcycle, when viewed by an approaching vehicle driver, and that reacts to the detection of a speeding vehicle in a manner that simulates initial law enforcement vehicle engagement.

More specifically, the device of the present invention in its preferred form is a specialized trailer equipped with a realistically-sized image reproduction of a police vehicle on an appropriate support member, wherein the police vehicle image placement relative to the trailer enables decoy use of the trailer tail lights as functional police vehicle lights, wherein traditional and functional siren lights are appropriately positioned relative to the police vehicle image, and wherein an on-board vehicle speed detection device engages the operation of the siren lights and decoy trailer tail lights. The radar and lighting features are powered via an on-board battery pack, preferably contained with a securable storage unit.

The portability of the device is enhanced with a foldable construction for the decoy and for the supportive frame that extends from the trailer for the decoy, wherein transport is further facilitated by removal of the siren lights with placement into the storage unit, in addition to the dimensional minimization of the overall device via folding. In order to facilitate effective utilization in a wide variety of positions relative to the monitored roadway, the police vehicle image reproduction may present a front, side, or rear view of a police vehicle, and may present a perspective view to enhance depth of field for the viewer, and thereby perceived authenticity.

It is envisioned that an alternate embodiment could feature functional re-creations of local law enforcement vehicle lights, such as head lights, tail lights, sirens, or the like, wherein these could be mounted on the trailer in lieu of or in addition to the decoy, and also in lieu of or in addition to use of standard trailer lights as a mimic.

It is further envisioned that an alternate embodiment could function with only the trailer component and the lighting features, that is, without the police vehicle image illusion, such that the lighting features would provide the principle effect, inherently maximized during nighttime hours. Additionally, the device could also function without the vehicle speed sensing capabilities, wherein a lighted, simulated decoy vehicle would remain, potentially with random light activation sequences. And further, the device could incorporate on-board camera capabilities in order to capture vehicle license plate or other visual identification information for further enhancing long-term enforcement.

Thus, a feature and advantage of the present invention is its ability to be utilized in essentially any setting with an appropriate shoulder or staging location and an ongoing flow of traffic.

Another feature and advantage of the present invention is its ability to offer a new manner of identification of speeders, with attendant illusion of citation threat to encourage immediate decrease in speed.

Still another feature and advantage of the present invention is its ability to eliminate the expense of a manned vehicle post.

Yet another feature and advantage of the present invention is its ability to provide a device capable of psychologically impacting speeding drivers in a manner directed toward the immediate reduction of vehicle speed.

Still yet another feature and advantage of the present invention is its ability to provide a vehicle speed detection device that not only detects vehicle speed, but causes the driver to become aware of and to decrease the vehicle speed based upon an orchestrated perception that he has been “caught”.

Yet another feature and advantage of the present invention is its ability to provide for easy, folded transport with minimized drag and/or damage potential.

Still another feature and advantage of the present invention is its ability to provide a plurality of decoy images, thereby enabling the maximized utilization of a single trailer in a plurality of locations according to the most realistic image, such as, for example, rear, side, or front view.

Another feature and advantage of the present invention is its ability to enhance pedestrian safety when utilized near schools, churches, road construction sites, and any other location where pedestrians are risk from speeding vehicles.

These and other objects, features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a perspective view of a device for prevention of speeding, according to the preferred embodiment of the present invention, showing the trailer with a decoy mounted thereto;

FIG. 2 is a front view of the device of FIG. 1, showing the display surface of the image reproduction;

FIG. 3 is an alternate decoy image reproduction; and

FIG. 4 is another alternate decoy image reproduction.

### DETAILED DESCRIPTION OF THE PREFERRED AND ALTERNATE EMBODIMENTS

In describing the preferred and alternate embodiments of the present invention, as illustrated in the figures and/or described herein, specific terminology is employed for the sake of clarity. The invention, however, is not intended to be limited to the specific terminology so selected, and it is to be understood that each specific element includes all technical equivalents that operate in a similar manner to accomplish similar functions.

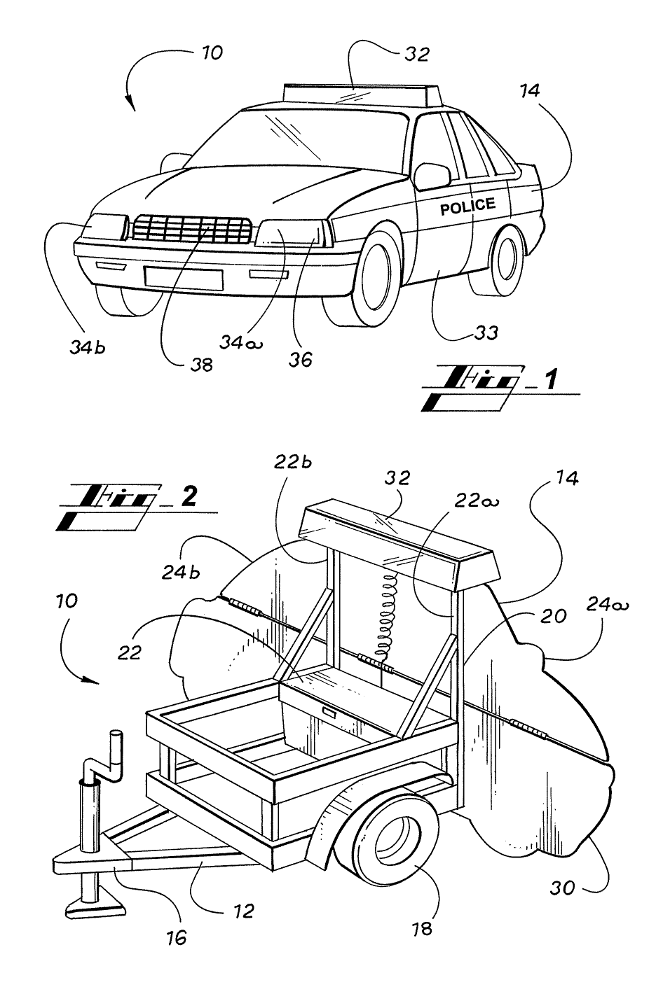

Referring now to FIGS. 1-4, the present invention in the preferred embodiment is a device for prevention of speeding 10, and the method thereof, comprising trailer 12 and decoy 14. Trailer 12 is depicted in FIG. 1 according to a preferred embodiment, however, as would be readily understood by one skilled in the art, would not be limited to such a trailer configuration. That is, any suitable trailer may be utilized to impart the structural support and transportability preferred for device 10. Preferred features of trailer 12 include hitch 16, wheels 18, frame 20, and box 22.

Frame 20 is preferably collapsible, with hinged or otherwise foldable arms 22a, 22b and hinged or otherwise foldable supports 24a, 24b. Preferably, foldable arms 22a, 22b are adapted to function as support members for decoy 14, namely for support substrate 30 and siren light unit 32. Of course, it should be readily recognized by one skilled in the art that many potential configurations exist for frame 20, and that the preferred form, as shown in FIG. 1, is not intended to be limiting. For example, frame 20 could be specifically configured to accommodate an embodiment of decoy 14 that defines the illusion of a motorcycle and/or to accommodate an embodiment of decoy 14 that is defined by four-sides during display in order to maintain the illusion when viewed from any angle. Moreover, depending upon the selected design for decoy 14, necessary dimensions for frame 20 may be adapted accordingly. That is, for smaller-sized versions of support substrate 30, such as in an oblique view decoy 14, a smaller frame 20 could be utilized and could facilitate tow transport of more than one device 10 for efficiently advantageous deployment thereof.

Decoy 14 preferably comprises substrate 30 and image decal 33, wherein decoy 14 is preferably hingedly foldable and substrate 30 defines a peripheral edge coincident with the shape of the image displayed on image decal 33 in order to enhance the effect of the illusion created thereby via realistic silhouette. Further realism is provided by decal/substrate apertures 34a, 34b, wherein the placement thereof relative to tail lights 36 of trailer 12 allows for transmission of light through decoy 14 at a realistic location on image decal 33, preferably proximate to an expected location for a running light, or the like.

Even further realism is provided by siren light 32, preferably supported by frame 20, and preferably positioned in a realistic and/or expected location for a siren light relative to image decal 33. Siren light 32 is preferably dual-action, wherein rotating and/or strobing lights that are commonly recognized as belonging to police vehicles provide visible recognition of device 10, even at a distance, and wherein siren broadcast provides recognizable audible warning, even in advance of visual sighting. One skilled in the art should readily recognize that although both features are preferred, device 10 could be configured without audible siren capabilities, wherein visual warnings would remain the focus of driver engagement.

Box 22 is preferably securely installed on trailer 12 in a manner that facilitates tamperproof positioning of vehicle speed evaluation device 38, such as a radar gun, laser measurement device, GPS-based device, or other suitable device. It is preferred that box 22 is dimensioned to receive siren light 32 therewithin for storage during transport of device 10 from one location to another. Power source(s) for trailer tail lights 36 and siren light 32 are also preferably contained within box 22, but further preferably during deployment, wherein battery power is preferred, but any suitable power mechanism may be utilized, such as, for example, solar power, or the like. It is preferred that vehicle speed evaluation device 38 is configured to operatively engage the operation of trailer tail lights 36 and siren light 32 upon detection of a vehicle that is traveling at a speed that exceeds a selected threshold. Such operative engagement may be according to any known mechanism in the art, including but not limited to microprocessor control, mechanical switch, or electronic circuitry.

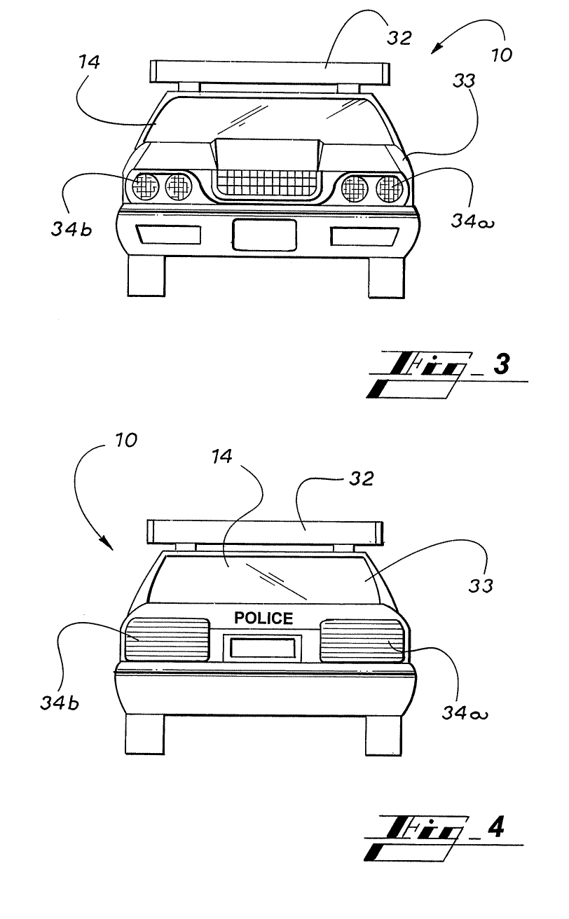

As noted hereinabove, it is preferred that decoy 14 is realistically full-sized relative to a genuine law enforcement vehicle. Also as noted, and as depicted in FIGS. 2-4, decoy 14 may present a front (FIG. 3), side, or rear (FIG. 4) view of a police vehicle, and may present a perspective view to enhance depth of field for the viewer, and thereby perceived authenticity. Further, as noted above, a combination of four such views may be cooperatively displayed in order to create a three-dimensional illusion, viewable from any angle. Moreover, the police vehicle of decoy 14 could be a motorcycle.

In an alternate embodiment, trailer 12 could be utilized without decoy 14, wherein only trailer lights 36 and siren light 32 could remain. Such an embodiment would necessarily reduce the illusion viability of the device, but would at least provide the principle effect, inherently maximized during nighttime hours, and further during daylight hours for more distantly positioned drivers.

In another alternate embodiment, device 10 could be configured without vehicle speed evaluation device 38, wherein functional decoy 14 could remain, potentially with random or timed period light activation sequences, or the like.

In still another alternate embodiment, device 10 could be adapted with a camera or other electronic means of collecting data regarding passing vehicles in order to enhance long-term enforcement by subsequent delivery of citations where appropriate.

In yet another alternate embodiment, trailer 12 could be configured to allow for removability of hitch 16, wherein such adaptation would serve to enhance security of device 10 by essentially preventing unauthorized transport and/or removal thereof.

In the preferred use, trailer 12 of device 10 is transported to a selected location, wherein decoy 14 is supported and displayed via frame 20 in a manner to create the appearance of a parked police car to passing and/or otherwise approaching vehicles. Preferably, while deployed, vehicle speed evaluation device 38 of device 10 assesses the speed of approaching vehicles and evaluates the detected speed relative to a selected threshold, wherein thereafter activation of siren light 32 and trailer lights 36 results. In such manner, the speeding driver is led to believe that engagement with a law enforcement officer is imminent, and surrounding drivers are also encouraged to recheck speed and/or general performance due to the perceived presence of a law enforcement officer, even if traveling in an opposing direction. Thereafter, as is desired, device 10 may subsequently be refolded and transported to a new location.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

I claim:

1. A device for prevention of speeding, comprising:
a trailer having lights;
a siren light;
a power source for said trailer lights and said siren light; and
an activation mechanism for lighting said trailer lights and said siren light.

2. The device of claim 1, further comprising:
an image reproduction of a law enforcement vehicle; and
a support substrate carried by said trailer, wherein said image reproduction is carried by said support substrate.

3. The device of claim 1, wherein said activation mechanism is operatively related to a vehicle speed evaluation device.

4. The device of claim 2, further comprising a frame, wherein said frame, said support substrate, and said image are foldable.

5. The device of claim 1, further comprising an audible effect, wherein said activation mechanism for lighting said trailer lights and said siren light further activates said audible effect.

6. The device of claim 1, wherein said device defines a portable, transportable, standalone vehicle speed detecting device, wherein said device delivers a fixed illusion of a realistically-sized police vehicle when viewed by an approaching vehicle driver, and wherein said device delivers a lighted function in response to detection of a speeding vehicle.

7. The device of claim 2, wherein said trailer lights and said image reproduction of a law enforcement vehicle are associated in such a manner as to render said trailer lights to appear as a set of functional lights on the law enforcement vehicle of said image reproduction.

8. The device of claim 2, wherein said siren light and said image reproduction of a law enforcement vehicle are associated in such a manner as to render said siren light to appear as a functional siren light on the law enforcement vehicle of said image reproduction.

9. The device of claim 1, wherein said power source is selected from the group consisting of a battery pack, solar source, wind source, or electrical connector.

10. The device of claim 9, wherein said power source is a battery pack contained within a securable storage unit.

11. The device of claim 1, wherein said siren light is removably stored within a securable storage unit.

12. The device of claim 1, wherein said image reproduction of a law enforcement vehicle displays one of a plurality of perspectives according to an intended use relative to a roadway, wherein said plurality of perspectives are selected from the group consisting of a front view, a side view, a rear view, or an angled view, and wherein said image reproduction of a law enforcement vehicle is selected from the group consisting of a car, a motorcycle, or a truck.

13. The device of claim 1, wherein said activation mechanism randomly activates said lights.

14. The device of claim 3, further comprising an image capture device activated by said activation mechanism.

15. The device of claim 4, wherein said frame further comprises a plurality of foldable arms and a plurality of foldable supports.

16. The device of claim 15, wherein said substrate and said siren light are supported by said plurality of foldable arms.

17. The device of claim 12, wherein a plurality of said image reproductions are employed to facilitate viewing of the law enforcement vehicle in said image reproduction from more than one angle.

18. The device of claim 2, wherein said image reproduction is a decal, and wherein said decal is applied to said substrate.

19. A method of decreasing the incidence of vehicle speeding comprising the steps of:
a) deploying an unmanned law enforcement post proximate a roadway, wherein said unmanned law enforcement post further comprises a police vehicle decoy-shaped structure and one or more light elements, and wherein each of said one or more light elements is visually functional;
b) activating said visual function of each of said one or more lights in response to a predetermined stimulus;
c) delivering a first manner of perceived threat of a citation by said visual function;
c) de-activating said visual function of each of said one or more lights upon the expiration of a predetermined time interval.

20. The method of claim 19, wherein said unmanned law enforcement post further comprises an audible element, wherein said audible element is activated in response to said predetermined stimulus, delivering a second manner of perceived threat of a citation by auditory function.
